(19) United States
(12) Patent Application Publication
(10) Pub. No.: US 2019/0036433 A1
(43) Pub. Date: Jan. 31, 2019

(54) Multi-Dimensional Layered Pulse Motor

(71) Applicant: Neil Smith, Sheffield (GB)

(72) Inventor: Neil Smith, Sheffield (GB)

(21) Appl. No.: 16/071,912

(22) PCT Filed: Feb. 18, 2017
(86) PCT No.: PCT/IB2017/050933

§ 371 Date: Jul. 23, 2018

(30) Foreign Application Priority Data
Feb. 18, 2016 (GB) 1602859.9

(51) Int. Cl. H02K 21/24; H02K 7/00; H02K 7/08; H02P 3/10; H02P 3/14; B60L 7/10; B60K 7/00

(52) U.S. Cl. CPC H02K 21/24; H02K 7/006; H02K 7/085; H02P 3/10; B60L 2220/50; B60L 7/10; B60K 7/0007; B60L 2220/44; H02P 3/14

(57) ABSTRACT

A pulse hub motor having coils (101) and magnets (107) interacting three dimensionally in x, y, and z axes to facilitate both increased power and efficiency through the ability to have more coils (101) in the motor, have each coil (101) perform both push and pull functions, and yet have the flexibility to only use the amount of coils (101) needed for real-time power requirements, whilst regenerating power in both normal drive and braking modes.

This invention relates to a pulse hub motor with power coils tilted and arranged in layers, in up to three dimensions.

The problem to solve was how to create a more powerful, efficient, and flexible pulse hub motor that could not only propel a vehicle, but was capable of collecting power and recharging the batteries not just in braking, but in normal use too.

To solve these problems, the present invention proposes a pulse hub motor comprising a stator that is fixed to a vehicle body, containing many coils arranged in 1 to n columns on the x axis, 1 to n rows on the y axis, and 1 to n extrusion layers on the z axis. Through the centre of the stator is a shaft that can rotate on a bearing. Attached to the shaft is a fixing plate onto which the rotor is bolted. The rotor makes up the outer part of the vehicle wheel, including rim and tyre.

Inside the rotor, magnets are fixed to the inner wheel rim and also to 1 to n extrusions through the z axis, arranged in such a way that they intertwine with the extrusions on the z axis of the stator, although the stator and rotor extrusions never actually make physical contact. Magnets are spaced to align with every other stator coil, and they are offset down the z axis layers such that the coils both push one layer of magnets whilst simultaneously pulling at another layer. Each layer of coils and magnets work together to produce thrust, and coils are fixed in place tilted by up to 10 degrees for stronger directional bias.

The coils of the x axis on the stator are arranged in a staggered format to facilitate a smoother drive motion.

Circuits are created such that every other coil on the y axis are pulsed together, along with the corresponding every other coil on the x axis. Coils on the next z axis layer inward are fired on the same pulse, however the coil that is fired is offset according to the active y axis coil.

Circuits are designed such that in normal drive, but lower power requirement situations such as a cruise or going downhill then parts of the x, y or z configuration can be switched off and can collect power as the magnets driven by the active coils pass over them.

Power can also be collected by the circuits as back-EMF from the collapsing magnetic fields of the coils.

Braking is achieved by reversing the polarity of the current to the coils. As with the driving scenario, light braking is controlled to use only the required x, y and z elements, with the redundant coils collecting power. Once stationary the parking brake should be applied.

Reverse is achieved by reversing the polarity of the current to the coils.

Control over which circuits are active will be maintained by a microcontroller. A microcontroller will also control the timing and power of pulses when at low speeds. At higher speeds the microcontroller will still control the power of each pulse, but the timing will be maintained by a transistor for each circuit, being activated by power from the magnets moving over a bifilar winding on a single coil in each circuit.

A parking/emergency brake mechanism is fitted beside the rotor fixing plate.

In conventional drive systems where thrust is delivered through the central shaft, a larger wheel is a disadvantage. The reverse applies with the motor in this invention wherein a larger wheel means more available thrust. Vehicle design should take this into account.

As a feature of this design is customisation, the number of circuits and therefore phases can be increased or decreased by adding or removing columns in the x axis. For demonstration purposes, the invention will now be described by way of a 4 phase example and with reference to the accompanying drawings in which:

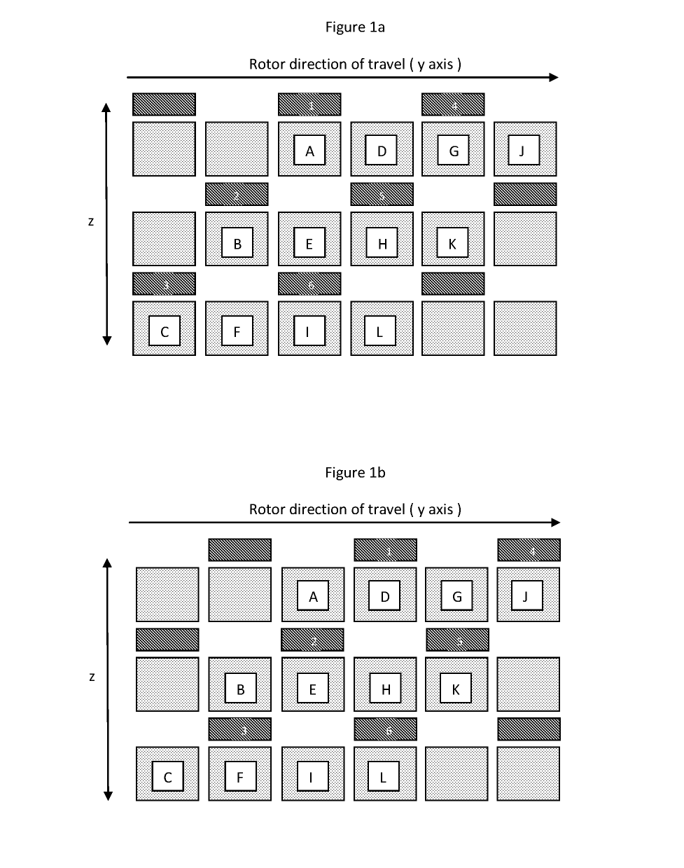

FIGS. 1a and 1b show a face-on cross section of a sample coil, magnet, and pulse configuration shown through the x axis horizontally and the z axis vertically, and describe the interactions in power and motion through phases 1 and 3,

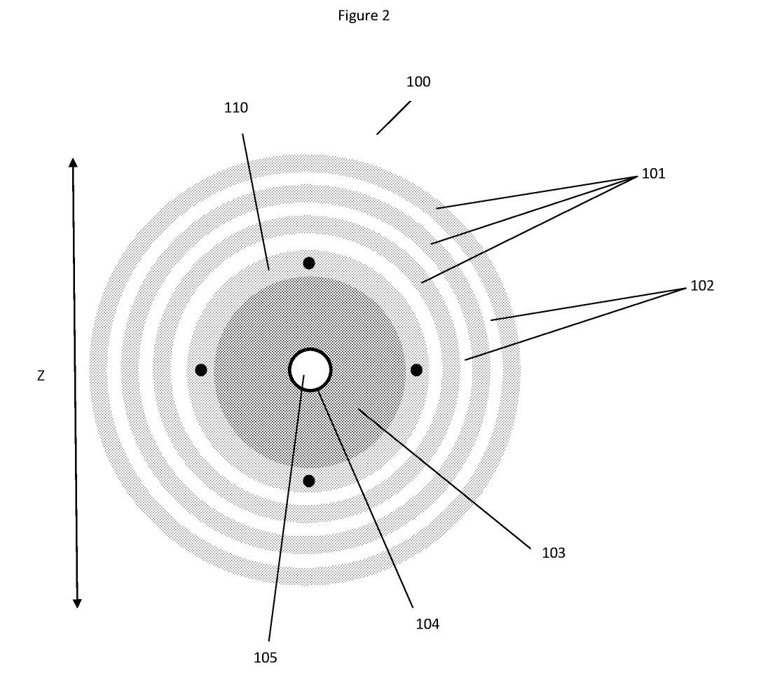

FIG. 2 shows an inside, face-on view of the stator,

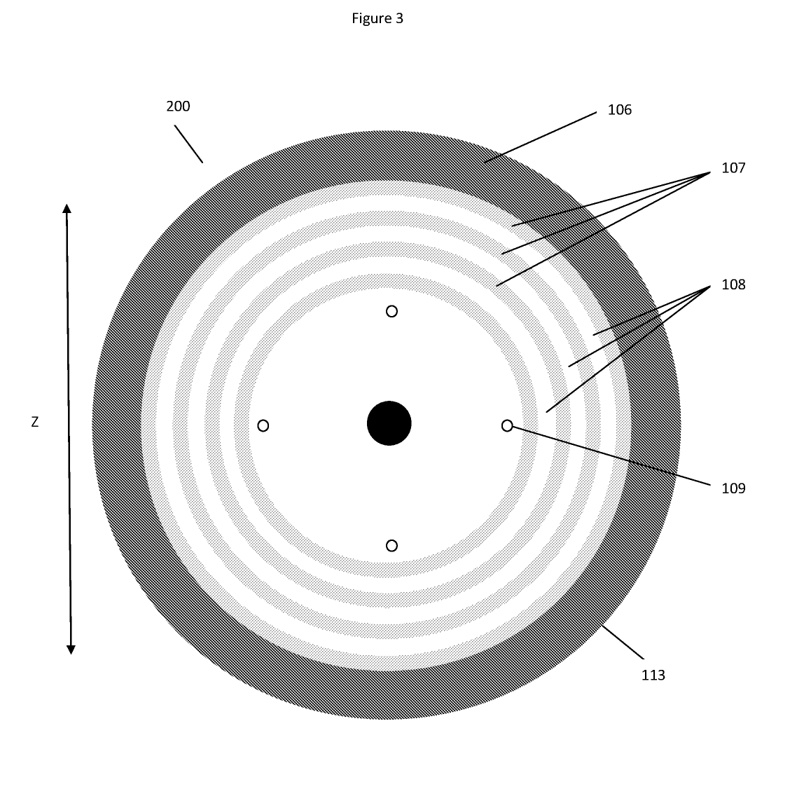

FIG. 3 shows an inside, face-on view of the rotor, being a car wheel with tyre,

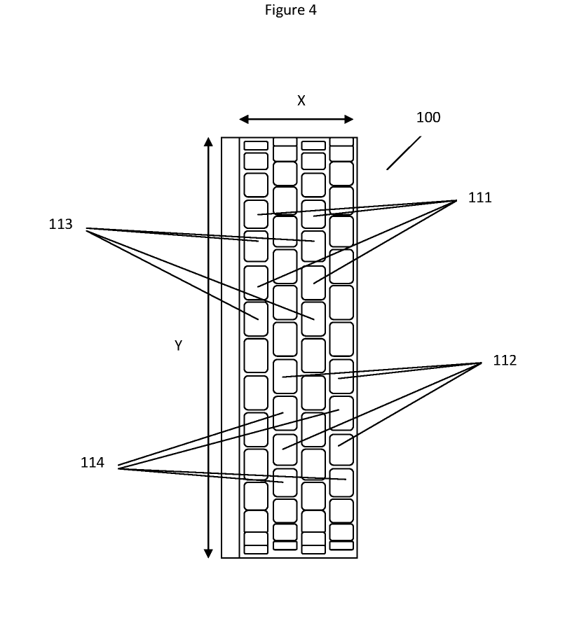

FIG. 4 shows a side view of the stator with coils arranged offset on the x and continuous on the y axes,

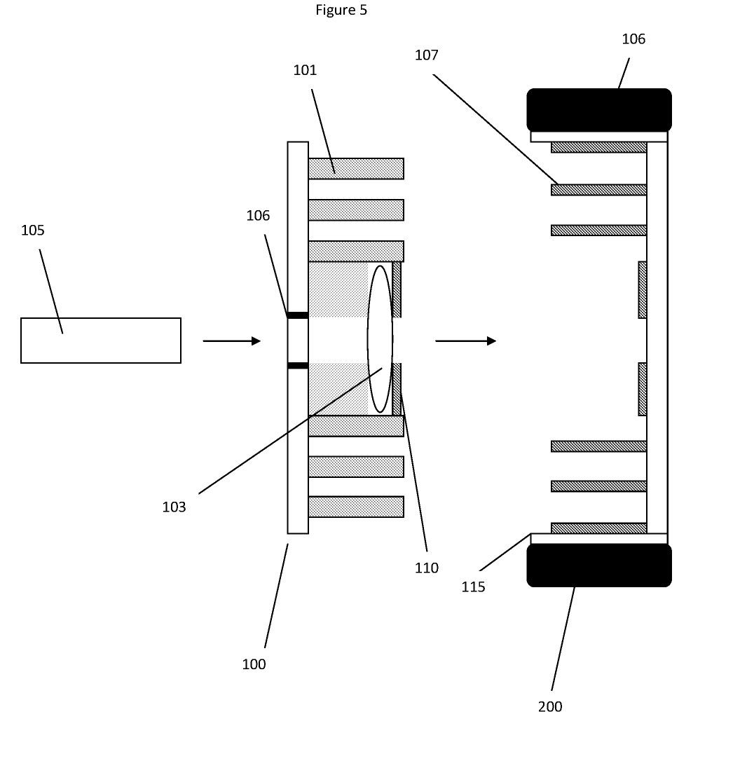

FIG. 5 shows a cross section of shaft, rotor, and stator separated,

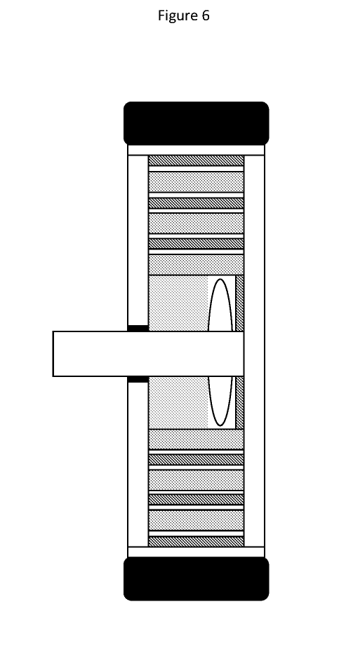

FIG. 6 shows the items in FIG. 4 connected,

### KEY

100=Stator
200=Rotor
101=stator extrusions containing coils
102=stator recesses to house rotor extrusions
103=parking/emergency brake mechanism
104=bearing
105=shaft socket
106=tyre
107=rotor extrusions containing magnets
108=rotor recesses to house stator extrusions
109=fixings
110=rotating fixing plate
111=sample of alternating x and y axes coils that would fire in a pulse in single circuit phase 1
112=sample of alternating x and y axes coils that would fire in a pulse in single circuit phase 2
113=sample of alternating x and y axes coils that would fire in a pulse in single circuit phase 3
114=sample of alternating x and y axes coils that would fire in a pulse in single circuit phase 4
115=Wheel rim

In FIG. 1a, a phase 1 pulse is fired through coils A, B, C, G, H and I. Coil A pushes Magnet 1 and at the same time pulls Magnet 2. Coil B pushes Magnet 2 and pulls Magnet 3. Coil C pushes Magnet 3. The same principle applies with Coils G, H and I, on Magnets 4, 5 and 6.

If practical, more layers and magnets can be added.

FIG. 1b shows the phase 3 pulse (phases 2 and 4 are identical, yet happen on a different x axis column and therefore are not shown in this example), where the magnets have now shifted to the next coils. In FIG. 1b, Coils D, E, F, J, K and L are fired. Coil D pushes Magnet 1 and at the same time pulls Magnet 2. Coil E pushes Magnet 2 and pulls Magnet 3. Coil F pushes Magnet 3. The same principle applies with Coils J, K and L, on Magnets 4, 5 and 6.

This process is replicated in each of the columns of the x axis. As coil columns in the x axis are purposefully offset with their neighbours (FIG. 4) this ensures that there is always a pulse in operation, the result of which is that the progression of the pulses and therefore the thrust is constant and smooth.

Coils can recycle energy from the movement of the rotor in both normal drive mode and braking mode by skipping phases if they are not required at that time.

The pulse hub motor mechanism is made possible by taking the stator (100 in FIGS. 2, 4 and 5), placing a shaft (105) through a bearing (106) in the centre, and attaching the rotor (200 in FIGS. 3 and 5) to the fixing plate (110).

The completed assembly produces the wheel in FIG. 6.

1. A pulse motor generator having a fixed stator disc comprising a plurality of concentric extruded rings arranged in a radial formation where the fixed stator disc joins a bearing inside which a shaft is free to spin;
and, a rotor disc comprising a plurality of concentric extruded rings arranged in a radial formation, where the rotor disc is fixed to the shaft;
and, the concentric extruded rings of the fixed stator disc and the concentric extruded rings of the rotor are arranged whereby the concentric extruded rings of the fixed stator disc fit into recesses between the concentric extruded rings of the rotor, and the concentric extruded rings of the rotor fit into recesses between the concentric extruded rings of the fixed stator disc;
and, the concentric extruded rings of the fixed stator disc contain a plurality of rings of electromagnetic coils through which current is passed to produce a magnetic force, the plurality of rings being stacked in layers along the x-axis, wherein each layer is an x-axis coil column;
and, the stator x-axis columns of electromagnetic coils are modular in that each can be added or removed if desired;
and, the concentric extruded rings of the fixed stator disc and the concentric extruded rings of the rotor are modular in that each can be physically removed if desired;
and, the x-axis coil columns are offset with their neighbours;
and, the concentric extruded rings of the rotor contain magnets that are spaced to align with every other coil in the adjacent concentric extruded ring of the fixed stator disc.

2. A pulse motor generator according to claim 1, where the magnets of the concentric extruded rings of the rotor are arranged such that a repulsive force from the stator x-axis columns of electromagnetic coils onto a magnet fixed to a concentric extruded ring of the rotor will coincide with an attractive force from the same electromagnetic coil onto a magnet fixed to the concentric extruded ring of the rotor at the opposite end of the electromagnetic coil.

3. A pulse motor generator according to claim 1, in which the electromagnetic coils forming the columns of the x-axis, rows of the y-axis, or layers of the z-axis of the concentric extruded rings of the fixed stator disc can be activated or shutdown of according to real-time thrust requirements.

4. A pulse motor generator according to claim 1, whereby columns of the electromagnetic coils in the x-axis of the concentric extruded rings of the fixed stator disc can be added or removed.

5. A pulse motor generator according to claim 1, where power is collected due to the motion of the magnets on the concentric extruded rings of the rotor in normal driving mode, from the electromagnetic coils of the concentric extruded rings of the fixed stator disc not currently receiving power from a motor power source.

6. A pulse motor generator according to claim 1, where power is collected due to the motion of the magnets the concentric extruded rings of the rotor in braking mode, from the electromagnetic coils of the concentric extruded rings of the fixed stator disc not currently receiving power from a motor power source.

7. A pulse motor generator according to claim 1, in which the electromagnetic coils of the concentric extruded rings of the fixed stator disc are arranged tilted at an angle from 0 to 10 degrees.

8. A pulse motor generator according to any of the preceding claims, in which thrust direction can be reversed by reversing the polarity of the electric current flow to the electromagnetic coils of the concentric extruded rings of the fixed stator disc.

9. A pulse motor generator according to any of the preceding claims, in which braking takes place by reversing the polarity of the electric current flow to the electromagnetic coils of the concentric extruded rings of the fixed stator disc.
